(19) United States
(12) Patent Application Publication
(10) Pub. No.: US 2020/0085119 A1
(43) Pub. Date: Mar. 19, 2020

(54) ILLUMINATED APPAREL

(71) Applicant: David Jacob McGee, Fairfax, VA (US)

(72) Inventor: David Jacob McGee, Fairfax, VA (US)

(21) Appl. No.: 16/573,614

(22) Filed: Sep. 17, 2019

Related U.S. Application Data
(60) Provisional application No. 62/733,146, filed on Sep. 19, 2018.

(51) Int. Cl. A41D 27/08; F21V 33/00; F21V 8/00

(52) U.S. Cl. CPC A41D 27/085; G02B 6/0006; F21V 33/0008

(57) ABSTRACT

An illuminated apparel includes a garment configured to be worn by a user. The garment includes at least one pocket, an outer surface, and an inner surface opposite the outer surface. At least one laser light emitter is removably attached to the garment. A battery is electrically connected to at least one laser light emitter. A fiber optic cable is stitched to the outer surface of the garment and includes an inlet receiving light from at least one laser light emitter.

### CROSS-REFERENCE TO RELATED APPLICATION

This application claims the benefit of priority of U.S. provisional application No. 62/733,146, filed Sep. 19, 2018, the contents of which are herein incorporated by reference.

### BACKGROUND OF THE INVENTION

The present invention relates to illuminated apparel and, more particularly, to apparel having a removeable laser and fiberoptic cable.

Electrically illuminated clothing currently utilize light emitting diodes (LEDs). The LEDs are permanently attached to the clothing such that the electrically illuminated clothing is not washable. Further, the entire emitter cabling system must be replaced when the emitter's service life is over.

As can be seen, there is a need for a removeable light emitter attached to clothing.

### SUMMARY OF THE INVENTION

In one aspect of the present invention, an illuminated apparel comprises: a garment configured to be worn by a user, the garment comprising at least one pocket, an outer surface, and an inner surface opposite the outer surface; at least one laser light emitter removably attached to the garment within at least one pocket; a battery electrically connected to at least one laser light emitter; and a fiber optic cable stitched to the outer surface of the garment and comprising an inlet receiving light from at least one laser light emitter.

These and other features, aspects and advantages of the present invention will become better understood with reference to the following drawings, description and claims.

### BRIEF DESCRIPTION OF THE DRAWINGS

FIG. 1 is a back view of an embodiment of the present invention;

FIG. 2 is a front view of an embodiment of the present invention;

FIG. 3 is a side view of an embodiment of the present invention;

FIG. 4 is a front perspective view of an embodiment of the present invention; and

FIG. 5 is an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

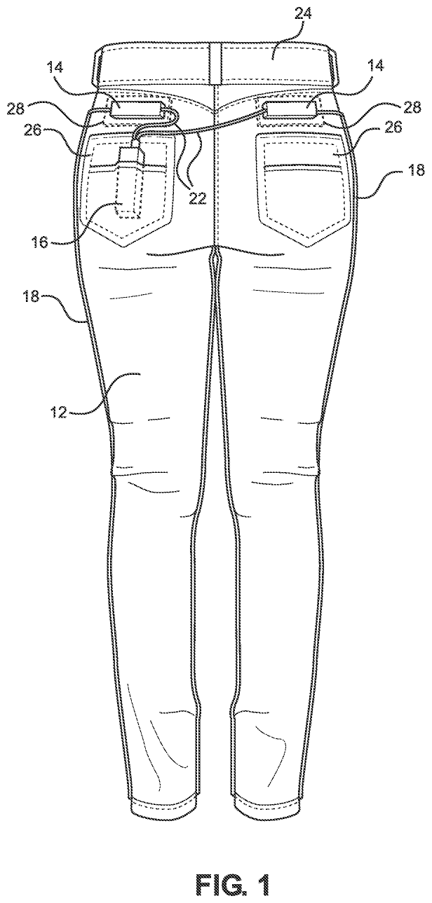

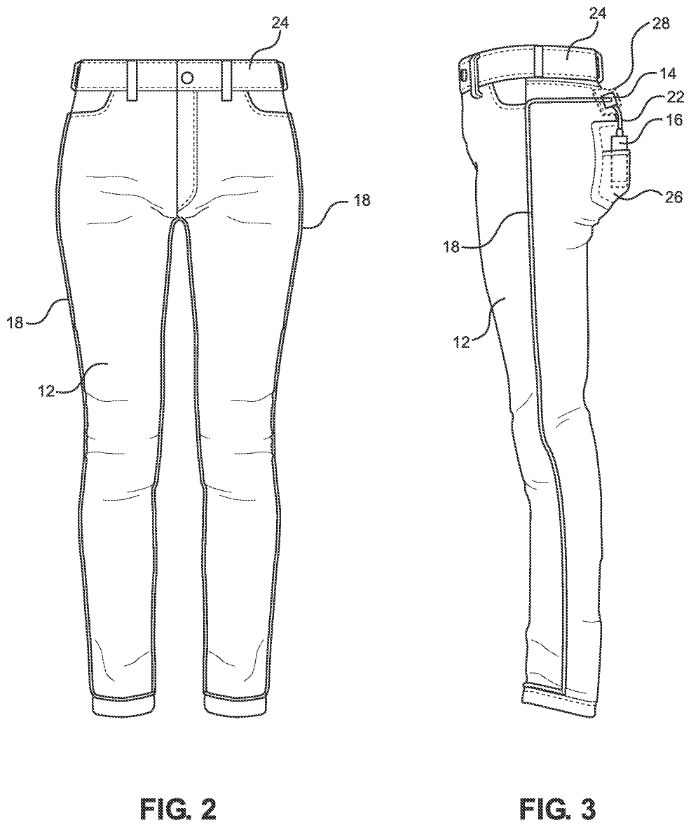

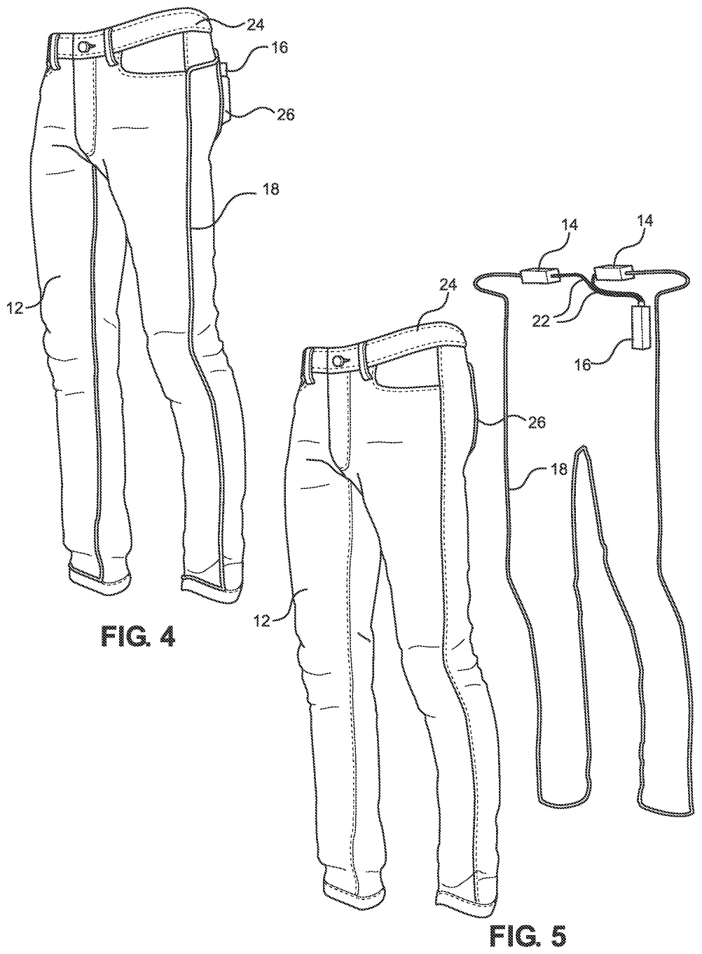

Referring to FIGS. 1 through 5, the present invention includes an illuminated apparel. The illuminated apparel includes a garment 12 configured to be worn by a user. The garment 12 includes at least one pocket 26, an outer surface, and an inner surface opposite the outer surface. At least one laser light emitter 14 is removably attached to the garment 12. For example, the laser light emitter 14 may be attached to the garment 12 within the sleeve 28 or may be clipped to the garment 12. A battery 16 is electrically connected to at least one laser light emitter 14. A fiber optic cable 18 is stitched to the outer surface of the garment 12 and includes an inlet receiving light from at least one laser light emitter 14.

The garment 12 may include, but is not limited to, shirts, shorts, jackets, sweatshirts, pants, jean pants, gloves, socks, footwear, and the like. As illustrated in the Figures, the garment 12 includes jean pants 24 with a pair of leg sleeves. The fiber optic cable 18 is sewn onto the outer surface of the jeans pants 24 along the paths of the seams to prevent excessive bending. For example, the fiber optic cable 18 is stitched to the outer surface of the garment 12 along a length of the pair of leg sleeves.

At least one laser light emitter configuration may include a first laser light emitter 14 and a second laser light emitter 14. At least one sleeve configuration may include a first sleeve 28 and a second sleeve 28. The first laser light emitter 14 is removably attached within the first sleeve 28 and the second laser light emitter 14 is removably attached within the second sleeve 28. The present invention uses detachable laser light emitters 14, which allows the user to detach the laser light emitters 14 from the garment 12 so that it can be washed through traditional liquid means.

The laser light emitters 14 may include 70mw laser light emitters that sit inside sleeves 28 above the left and right rear pockets 26 of the jeans 24. In certain embodiments, the laser light emitters 14 each produce a single color. Each laser light emitters 14 may then fade their respective color off and on at different timed intervals. For example, if a red laser light emitter fades at the same time as a green laser light emitter, the garment 12 may first glow red, then orange as the two colors mix and then fade green as the red laser light emitters fades out. These can be set to fade, blink, or be constantly on. The laser light emitters 14 can also be changed to use different colors.

The fiber optic cable 18 of the present invention may include a translucent fiber having a diameter that may be approximately 2 mm. The translucent fiber may be made of a polymer such as Poly(methyl methacrylate), or a glass fiber. In certain embodiment, an opaque shrink wrap tubing covers the fiber optic cable 18. For example, white or black shrink-wrap tubing covers the fiber optic cable 18 until it enters the inside of the garment 12 through a pass-through hole made in the exterior of the garment 12. The fiber optic cable 18 may then be covered in a white or black shrink-wrap tubing until it exits the garment 12 again through another pass-through hole, or it rolls onto the upper edge of the waist band from garment 12 and then rolls back inside the edge of the garment 12, into shrink wrap tubing and then back to the second laser light emitter 14. The present invention may include a single fiber optic cable 18 having two ends. The first end may run from the first laser light emitter 14, may run along the inner and outer seams of the jeans 24 and the second end may connect to the second laser light emitter 14. In other embodiments, the present invention may utilize multiple fiber optic cables 18.

The fiber optic cable 18 is stitched to the outer surface by a transparent polymer thread. The transparent polymer thread may include a nylon, or polyester fishing line or other stitching material. The present invention may use nearly six meters of fiber optic cable 18, and nearly seven meters of transparent polymer thread. The present invention may utilize a circular stitch that measures about five to six stitches per inch and completely encircles the fiber optic cable 18 as it travels along the garment 12, usually following a pre-existing seam to limit bending of the fiber optic cable 18 and prevent it from possibly breaking.

As mentioned above, the power source of the laser light emitters 14 is a rechargeable battery 16. The battery 16 may be coupled to the laser light emitters 14 or separate from the laser light emitters. For example, the battery 16 is a battery pack removably attached within a garment 12 pocket 26 and electrically connected to the first laser light emitter 14 and the second laser light emitter 14 by electrical wiring 22.

It should be understood, of course, that the foregoing relates to exemplary embodiments of the invention and that modifications may be made without departing from the spirit and scope of the invention as set forth in the following claims.

What is claimed is:

1. An illuminated apparel comprising:
a garment configured to be worn by a user, the garment comprising an outer surface, and an inner surface opposite the outer surface;
at least one laser light emitter removably attached to the garment;
a battery electrically connected to at least one laser light emitter; and
a fiber optic cable stitched to the outer surface of the garment and comprising an inlet receiving light from at least one laser light emitter.

2. The illuminated apparel of claim 1, wherein the garment is jean pants comprising a pair of leg sleeves.

3. The illuminated apparel of claim 2, wherein the fiber optic cable is stitched to the outer surface of the garment along a length of the pair of leg sleeves.

4. The illuminated apparel of claim 1, wherein the garment comprises at least one pocket, wherein at least one laser light emitter is removably attached within the pocket or a sleeve.

5. The illuminated apparel of claim 4, wherein at least one laser light emitter configuration comprises a first laser light emitter and a second laser light emitter.

6. The illuminated apparel of claim 5, wherein at least one pocket comprises a first pocket or sleeve, and a second pocket or sleeve, wherein the first laser light emitter is removably attached within the first pocket or sleeve and the second laser light emitter is removably attached within the second pocket or sleeve.

7. The illuminated apparel of claim 6, wherein the battery is a battery pack removably attached within a pocket and electrically connected to the first laser light emitter and the second laser light emitter by electrical wiring.

8. The illuminated apparel of claim 1, further comprising an opaque shrink wrap tubing covering the fiber optic cable.

9. The illuminated apparel of claim 1, wherein the fiber optic cable is stitched to the outer surface by a transparent polymer thread.

10. The illuminated apparel of claim 1, wherein the fiber optic cable is Poly(methyl methacrylate).
